(19) United States
(12) Patent Application Publication
(10) Pub. No.: US 2015/0156322 A1
(43) Pub. Date: Jun. 4, 2015

(54) SYSTEM FOR PROVIDING CONTACT NUMBER INFORMATION HAVING ADDED SEARCH FUNCTION, AND METHOD FOR SAME

(71) Applicants: Se-yong Lee, Seoul (KR); Kyo-sik Hong, (US); TW MOBILE CO., LTD., Seoul (KR)

(72) Inventors: Se-yong Lee, Seoul (KR); Kyo-sik Hong, Ansan (KR); Ki-won Nam, Seoul (KR); Hyun-jong Song, Seoul (KR)

(21) Appl. No.: 14/414,961

(22) PCT Filed: Jul. 9, 2013
(86) PCT No.: PCT/KR2013/006105

§ 371 Date: Jan. 15, 2015

(30) Foreign Application Priority Data
Jul. 18, 2012 (KR) 10-2012-0078471

(51) Int. Cl. H04M 3/51; H04M 3/42

(52) U.S. Cl. CPC H04M 3/5191; H04M 3/42102

(57) ABSTRACT

Disclosed are a representative telephone information providing system having a search function and a method thereof. The system includes: a user terminal having a ring data search function to receive ring data which include business information or information on an ARS service or a telephone number of a person in charge for a specific department so as to release a session for a data communication network, and extract and output screen data depending on a key operation signal of a user with the session being released; and a ring data management server which receives the ring data including the business information or the information on the ARS service from a seller and upload the received ring data to be searched, extract the ring data corresponding to search words transmitted from the user terminal, and transmit the extracted ring data to the user terminal.

### BACKGROUND OF THE INVENTION

1. Field of the Invention

The present invention relates to a representative telephone information providing system having a search function and a method thereof, and more particularly, to a representative telephone information providing system having a search function and a method thereof, which interwork a search function to provide a ring data service which includes business information and a key operation signal interworking ARS screen data packet for performing an ARS service or telephone number information on persons in charge for specific departments and to release a session on a data communication network so as to perform screen processing depending on the key operation signal selected by a user while remarkably reducing traffic, thereby largely improving convenience and economic efficiency, a method thereof.

2. Description of the Related Art

As is well known, with the recent development of information communication technologies, a development of information providing technologies which provide information on various fields to multiple subscribers through at least one host server via a wide area data communication network in real time has been actively conducted.

Based on the technologies, recently, a peripheral technology, such as a cache memory extension technology for more rapidly providing accurate information to subscribers and an information selection technology and a compression technology providing a more convenient access according to taste and preference of subscribers are being developed. Further, the development of various contents and a solution using these technologies is accelerating.

With the industrial development, providing an answer to various customer query sentences before and after sale of products, as well as during delivery of products, and related information which are a strengthening plan of a service system for sale of products is also a part of the important marketing, which has a great effect on sales of selling companies. However, as the number of counselors is increased, a burden of labor costs rises.

In particular, a financial company, etc., requires many counselors due to a lot of questions and answers, but may not hire many counselors for the same economic reasons. Therefore, recently, when a user selects a preprogrammed path using an ARS service, the corresponding answer is automatically extracted and output. Finally, even though the user is connected with a counselor, membership information or card information is previously acquired through the ARS service, and therefore rapid counseling may be made.

However, in the case of using an ARS system, a user may not rapidly enter his/her desired items and may not determine what the user desired item number is until he/she listens to a voice output from a receiver one by one.

Further, in the case of persons with poor hearing ability such as deaf people and aged people or in the case in which surrounding environment is very loud, at the time of using the ARS service, the ARS service is often unlikely to go smoothly.

Therefore, a method for allowing a user to receive an ARS service through a screen while reading information displayed on the screen provided by a server with a user's telephone terminal accessing a server through a wireless Internet may be considered.

In this case, all the ARS providers need to include a system for providing the ARS service on the screen through the wireless Internet, and therefore have to pay a lot of money. The user's telephone keeps with being connected to the sever which continuously provides the ARS screen while the user receives the ARS service through the screen, and therefore even though traffic imposed on the server to provide the ARS screen service is not large, line traffic for keeping a simultaneous connection with a plurality of telephones is very large. For this reason, the server is highly likely to be down and when capacity extension is required to stably keep the server, a financial burden is increased.

Conventionally, when the user wants to talk to a specific person in charge which works at a specific department of a specific company through a search engine, he/she may input the corresponding company name through the search engine to search and select homepage URL information of the company, access the homepage of the corresponding company to read a main page, read a sub page, on which the department information is posted, in the main page, and then know a telephone number of the person in charge from the sub page.

However, the user may not directly call the person in charge through the homepage, and therefore memorizes the telephone number or again inputs the telephone number to his/her own telephone and calls the person in charge.

In such a structure, users who want to talk to the person in charge for the corresponding company need to select and read too many web pages, and therefore there are many inconveniences. When users want to talk to a counselor or the corresponding person in charge through the ARS, there is a need for voice calls for a long period of time.

Meanwhile, in the case of small business owners who do not have the ARS system or home page uploaded on the Internet, to propagate their own business information and construct and manage the ARS system or the home page, they have to pay a lot of money.

### SUMMARY OF THE INVENTION

Accordingly, it is an object of the present invention to provide a representative telephone information providing system having a search function and a method thereof, which interwork a search function to provide a ring data service which includes business information and a key operation signal interworking ARS screen data packet for performing an ARS service or telephone number information on persons in charge for specific departments and to release a session on a data communication network so as to perform screen processing depending on the key operation signal selected by a user while remarkably reducing traffic, thereby largely improving convenience and economic efficiency, a method thereof.

In order to accomplish the object, according to an aspect of the present invention, there is provided a representative telephone information providing system, including: a user terminal having a ring data search function to receive ring data which include business information or information on an ARS service or a telephone number of a person in charge for a specific department so as to release a session for a data communication network, and extract and output screen data depending on a key operation signal of a user with the session being released; and a ring data management server configured to receive the ring data which include the business information or the information on the ARS service or the telephone number of a person in charge for a specific department from a seller and upload the received ring data to be searched, extract the ring data corresponding to search words transmitted from the user terminal, and transmit the extracted ring data to the user terminal.

Preferably, the user terminal is equipped with applications which extract predefined screen data depending on a specific key signal input by a user and output the extracted data on a screen.

Preferably, each of the screen data, which is output depending on the key selection information posted on the screen data which is exposed on the current screen, has a unique identification code allocated thereto.

Preferably, the ring data include a plurality of ARS screen data packets which are output on the screen depending on a key selection with the user terminal being connected to the ARS telephone numbers of each business.

Preferably, the ring data include product information or advertising information of the business.

Preferably, the ring data are hyperlinked to generate a call signal at the time of selecting a telephone number included therein.

Preferably, the ring data include at least one of the business information, and information on the ARS service or the telephone number of a person in charge for a specific department.

Preferably, the user terminal comprises: a communication module which is connected to a voice communication network or a data communication network in the user terminal to perform communications; a ring data output application manager configured to manage a driving of a ring data output application; a ring data receiver configured to receive ring data of a searched business; a search word transmitter configured to transmit the search words input by the user to the ring data management server; a button operation signal analyzer configured to analyze button signals input by the user; a matching screen extractor configured to extract the screen data matched to the button signals input by the user; a voice data output unit configured to output voice data output by being call connected to a telephone number; a screen data output unit configured to output the pre-matched screen data on a screen depending on the button selection; a data storage unit configured to store the ring data including the screen data packet, and store key operation information matched so as to output each screen data and the identification codes for each screen data; and a controller configured to perform a control to transmit the input search words to the ring data management server by driving the ring data output application, and receive the ring data corresponding to the result so as to selectively output the plurality of screen data included in the ring data on the screen, corresponding to the key operation signal input by the user.

Preferably, when selecting the ARS telephone number of the ring data, the controller performs a control to extract the screen data by matching the button selection of the user at the time of ARS voice communication and output the extracted screen data on the screen.

According to another aspect of the present invention, there is provided a representative telephone information providing method, including: a first step of driving a ring data output application equipped in a user terminal; a second step of determining whether search words are input to a search input window of the ring data output application; a third step of transmitting, by the ring data output application of the user terminal, the search word to the ring data management server; a fourth step of searching for, by the ring data management server, the search word in a database; a fifth step of extracting, by the ring data management server, ring data matched to the search word and transmitting the extracted ring data to the user terminal; a sixth step of releasing, by the ring data management server, session setting; a seventh step of determining, by the ring data output application of the user terminal, whether a key selection signal is input; a eighth step of extracting screen data matched to the key selection signal through the ring data output application and outputting the matched screen data, when the specific key selection signal is input; a ninth step of determining, by the user terminal, whether a telephone number selection signal included in the screen data is applied; and a tenth step of generating a call signal to the telephone number.

Preferably, the ring data are a packet including a plurality of screen data.

Preferably, wherein each screen data included in the ring data is allocated with a unique identification code for each key signal so as to output the screen data depending on the key operation signal selected by a user.

Preferably, the representative telephone information providing method further includes: before the first step, a step of receiving, by the ring data management server, the ring data including business information and telephone number information from a plurality of businesses; and a step of matching the ring data with a searchable search word tip.

Preferably, the telephone number is at least one of a business representative telephone number, a business ARS telephone number, a department telephone number, and telephone numbers of persons in charge for each department.

Preferably, the representative telephone information providing method further includes: when the telephone number is an ARS telephone number in the tenth step, after the tenth step, an eleventh step of executing, by the user terminal, a call connection to the ARS number; a twelfth step of outputting screen data having the same content as a ARS voice content; a thirteenth step of determining whether a key selection signal is applied; a fourteenth step of extracting and outputting the screen data matched to the key selection signal; and a fifteenth step of determining whether a call ending signal is applied.

According to the representative telephone information providing system having a search function and the method thereof in accordance with the present invention, it is possible to output the web page through the wireless Internet, by receiving the ring data including the plurality of screen data which includes the telephone number information as the result of the specific search word and selectively outputting the matched screen data to the user terminal depending on the key selection of the user despite with the user terminal being disconnected to the server which downloads the ring data. As the result, it is possible to remarkably improve the overall communication environment by making the user reliably recognize the business information and more conveniently acquire the telephone number information and very efficiently reducing the traffic for the corresponding server.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a state in which ring data are output after performing a search using a representative telephone information providing system having a search function according to an embodiment of the present invention;

FIG. 2 is a schematic diagram illustrating a configuration of the representative telephone information providing system having a search function according to the embodiment of the present invention;

FIG. 3 is a diagram illustrating a data flow state of the representative telephone information providing system having a search function according to the embodiment of the present invention;

FIG. 4 is an exemplified diagram of a screen illustrating an output state of a screen composite mode which is implemented by the representative telephone information providing system having a search function according to the embodiment of the present invention;

FIG. 5 is a schematic diagram illustrating a configuration of a user terminal included in the representative telephone information providing system having a search function according to the embodiment of the present invention; and

FIG. 6 is a flow chart illustrating a signal flow of the representative telephone information providing system having a search function according to the embodiment of the present invention.

### DETAILED DESCRIPTION OF THE INVENTION

Hereinafter, an exemplary embodiment of the present invention will be described in detail with reference to the accompanying drawings.

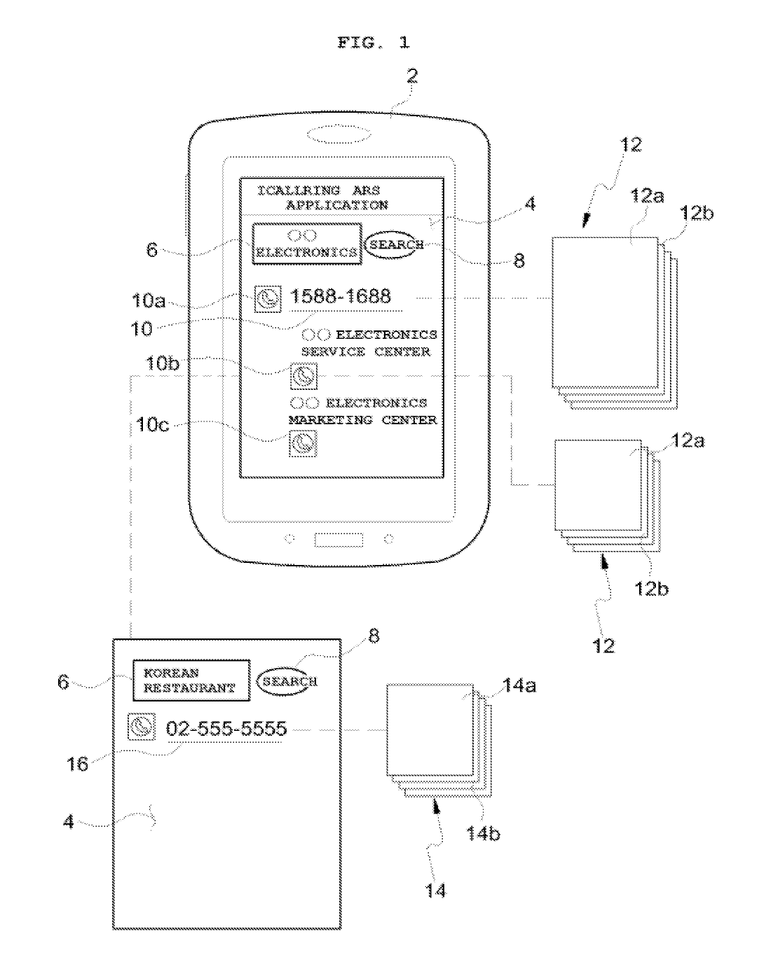

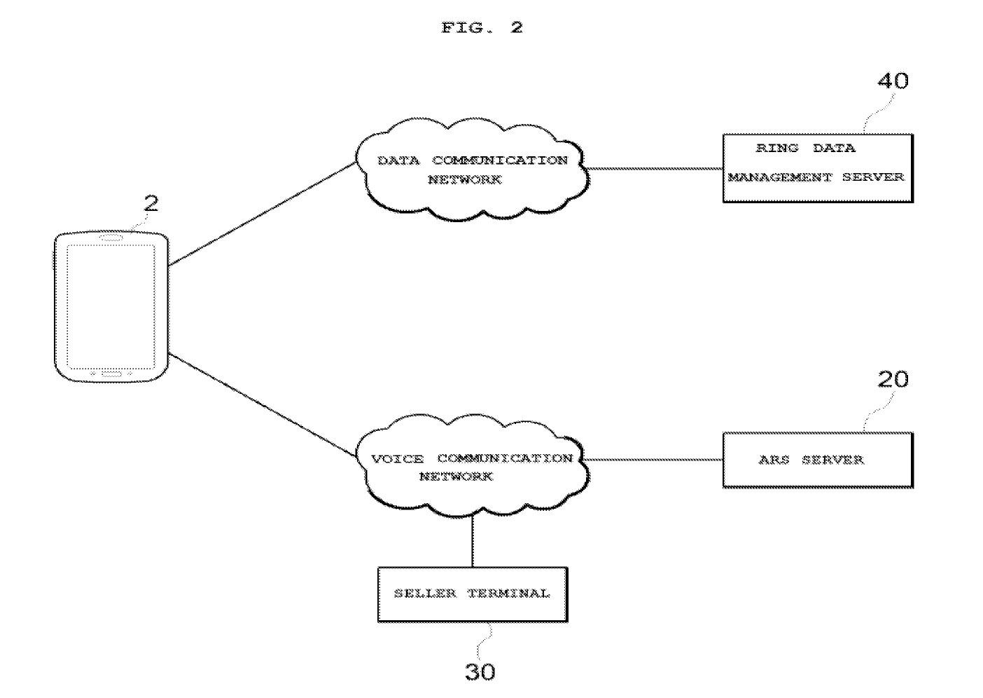

FIG. 1 is a diagram illustrating a state in which ring data are output after performing a search using a representative telephone information providing system having a search function according to an embodiment of the present invention, and FIG. 2 is a schematic diagram illustrating a configuration of the representative telephone information providing system having a search function according to the embodiment of the present invention.

Referring to FIGS. 1 and 2, the representative telephone information providing system having a search function according to the embodiment of the present invention interworks a search function to provide a ring data service which includes business information or a key operation signal interworking ARS screen data packet for performing an ARS service or telephone number information on persons in charge for specific departments, and release a session on a data communication network so as to perform screen processing depending on the key operation signal selected by a user while remarkably reducing traffic, thereby largely improving convenience and economic efficiency.

In more detail, the representative telephone information providing system having a search function according to the embodiment of the present invention receives the ring data including a plurality of screen data as a result of a specific search word through applications.

In this state, it is possible to output the web page through the wireless Internet, by selectively outputting the matched screen data to a user terminal 2 depending on the key selection of the user despite with the user terminal being disconnected to the server which downloads the ring data.

As the result, it is possible to remarkably improve the overall communication environment by making the user reliably recognize the business information, more conveniently acquire the telephone number information, and very efficiently reduce the traffic for the corresponding server.

For this purpose, the representative telephone information providing system having a search function according to the embodiment of the present invention includes the user terminal 2 which has a ring data search function to receive ring data including business information or information on an ARS service or a telephone number of a person in charge for a specific department so as to release a session for a data communication network and extract and output screen data depending on a key operation signal of a user with the session being released.

Further, the representative telephone information providing system having a search function according to the embodiment of the present invention includes a ring data management server 40 which receives the ring data which include the business information or the information on the ARS service or the telephone number of a person in charge for a specific department from a seller and uploads the received ring data to be searched, extracts the ring data corresponding to search words transmitted from the user terminal 2, and transmits the extracted ring data to the user terminal 2.

The ring data mainly represent the plurality of screen data including the information or telephone number on the specific business. The ring data are managed with being uploaded in the ring data management server 40, so as to allow unspecified users to search and download the ring data.

The ring data are the information or a telephone number on the specific business, and therefore may include various business information, such as positional information or an abbreviation of the corresponding business, products to be sold, and price information of products, which are formed as the screen data. The telephone number information refers to representative telephone number information or ARS telephone number information which may be directly connected to a counselor or information on a telephone number of a specific department or a telephone number of persons in charge for the specific department.

Meanwhile, the user terminal 2 is equipped with applications which extract predefined screen data depending on a specific key signal input by the user and output the extracted data on the screen.

Therefore, the user terminal 2 searches the ring data of the specific business and downloads the searched ring data, and then selects whether to make a voice call to a counselor, a connection to ARS, and a telephone connection with a specific person in charge for a specific department from the main screen data despite with the user terminal 2 being disconnected to the ring data management server 40, and thus an effect just like a state in which the user terminal 2 is connected to a wireless Internet network may be obtained.

Further, even small business owners who have only one telephone number may obtain the same effect as operating a wireless home page.

In particular, in case of a businesses operating the ARS system, it may be configured in such a way that the user terminal 2 receives a service through a voice communication network by accessing the ARS system of the specific business, and receives a plurality of screen data interworking the corresponding service in advance, so at to output on the screen depending on the key selection signal through a ring data output application.

That is, when selecting an ARS telephone number through the user terminal 2, the screen data which are simultaneously output interworking with a voice output of the ARS are output depending on the key signal selected by the user. For example, the user may also select an ARS telephone number while reading ring data of ‘Kookmin bank’ which is downloaded from the ring data management server 40 by inputting a search word called ‘Kookmin bank’ with the user terminal 2 being disconnected to the ring data management server 40 in advance.

When the user selects the ARS telephone number, the user terminal accesses an ARS center of ‘Kookmin bank’ through the voice communication network and main screen data having the same content as a voice output from the ARS center are output on the screen of the user terminal 2.

That is, it seems like that the wireless Internet is connected to the user terminal 2 and thus the ARS screen data are output to the user terminal 2, but actually, the ring data output application extracts and outputs the previously matched screen data depending on the key signal selected by the user.

Therefore, the user may input a specific number as soon as he/she confirms the information of the screen data without listening to all the ARS voice data, and the ring data output application extracts and outputs another screen data matched to the corresponding number.

When ring data output application equipped in the user terminal 2 is driven, the main screen 4 including an input window 6 through which search words are input is output. Here, when a search button 8 is clicked by input a specific search word to the input window 6, the search result is transmitted from the ring data management server 40 to be output on the screen. By this time, the user terminal 2 continuously accesses the ring data management server 40 through the wireless Internet.

The search result may be one or a plurality of information. For example, when selecting ∘∘ Electronics, the ARS telephone number 10 of the ∘∘ Electronics is also output, and ∘∘ Electronics service center information or marketing center information may also be searched.

Preferably, positions corresponding to the telephone number among the respective searched data may include icons 10a, 10b, 10c . . . , respectively, which may generate a call signal.

When a user selects specific call signal generation icons 10a, 10b, 10c . . . , the ring data management server 40 extracts the ring data 12 and 14 matched to the corresponding search result and transmits the extracted ring data 12 and 14 to the user terminal 2.

The reason of denoting the ring data by different reference numerals is to differentiate between a case in which the ARS interworking screen data are included in the ring data and a case in which the ARS interworking screen data are not included in the ring data. The ring data 14 of a general business owner include business information, product information for sale, and the like.

Each ring data 12 and 14 includes a plurality of screen data 12a, 12b, 12c . . . and 14a, 14b, 14c . . . and each screen data is allocated with screen identification codes and thus is selectively output, interworking a button number selected by the user.

That is, each of the screen data, which may be output depending on the key selection information posted on the screen data which is exposed on the current screen, has a unique identification code allocated thereto.

In particular, the ring data may include a plurality of ARS screen data packets which may be output on the screen depending on the key selection with the user terminal 2 being connected to the ARS telephone numbers of each business. The ring data may also include product information or advertising information of the business.

Meanwhile, the ring data may be hyperlinked to generate a call signal when selecting the telephone number included in the ring data.

Further, the ring data include at least one of the business information and information on an ARS service or a telephone number of a person in charge for a specific department.

In addition, the representative telephone information providing system having a search function according to the embodiment of the present invention further includes a seller terminal 30 for transmitting the ring data to the ring data management server 40.

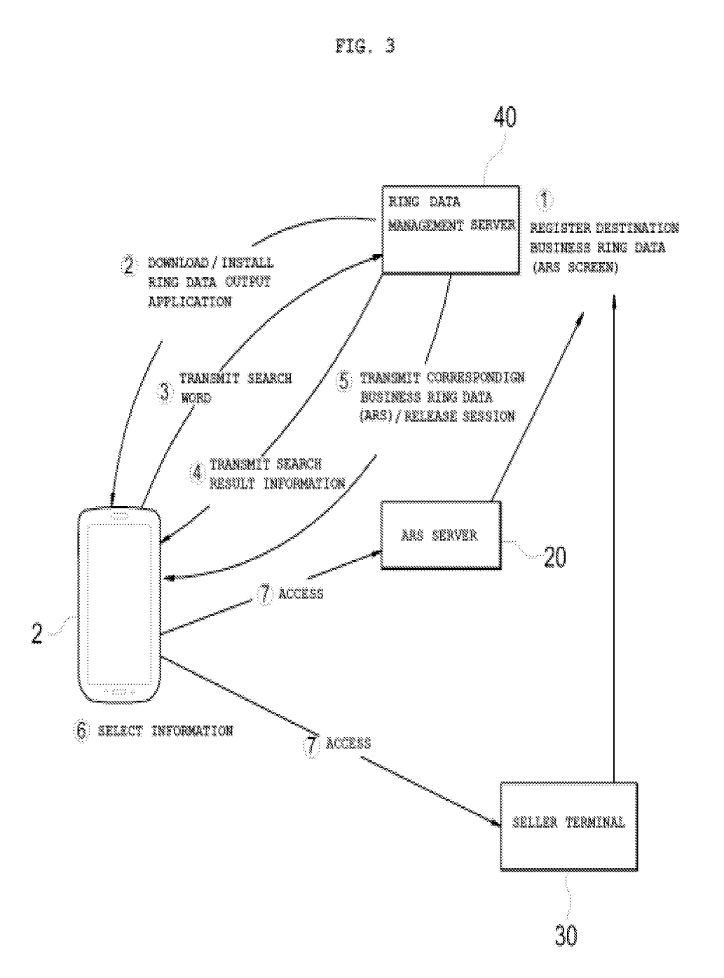

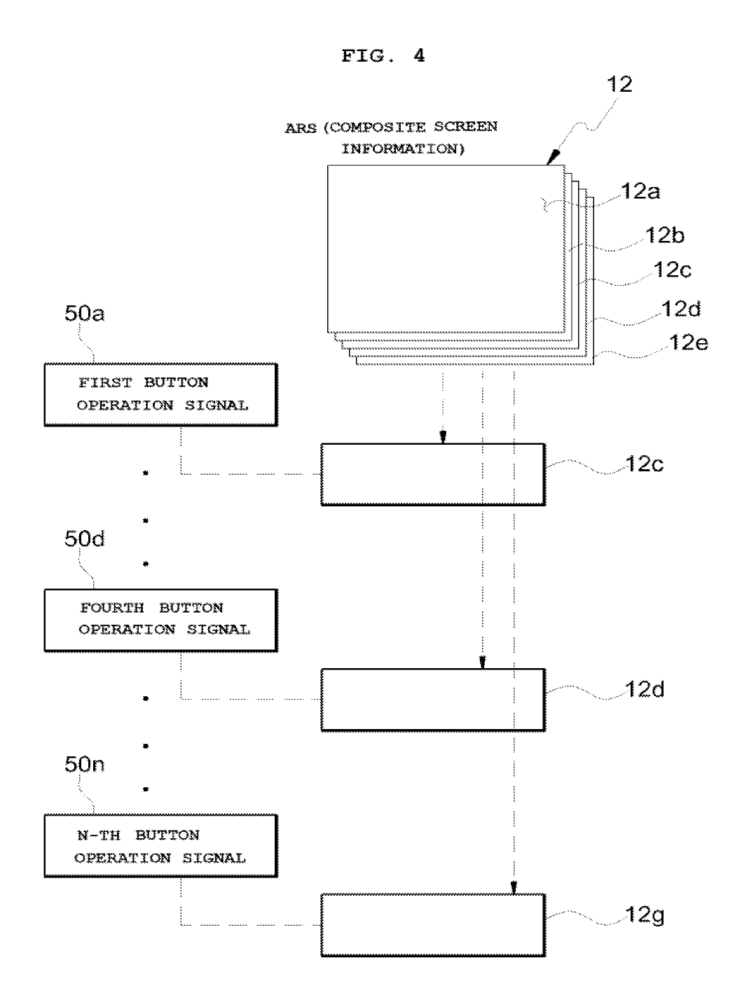

FIG. 3 is a diagram illustrating a data flow state of the representative telephone information providing system having a search function according to the embodiment of the present invention, and FIG. 4 is an exemplified diagram of a screen illustrating an output state of a screen composite mode which is implemented by the representative telephone information providing system having a search function according to the embodiment of the present invention.

Referring to FIGS. 3 and 4, the seller terminal 30 transmits its own ring data to the ring data management server 40 and registers the ring data therein.

Therefore, the ring data management server 40 receives the ring data of a plurality of destination businesses and registers the received ring data to be downloaded.

Further, a user downloads and installs the ring data output application from the ring data management server 40 to the user terminal 2.

In this state, the user drives the ring data output application to input a search word of a specific business to the user terminal 2.

Then, the search word are transmitted to the ring data management server 40, and the ring data management server 40 extracts the ring data of the corresponding business and transmits the extracted ring data to the user terminal 2.

Therefore, the user may read the ring data and select any one telephone number. In this case, the user may directly call a business associated with the search word and may also call the ARS server 20 of the corresponding business.

The ring data 12 downloaded to the user terminal 2 also include the ARS interworking screen data, and therefore the ARS related screen data are selectively output, corresponding to button operation signals 50a, 50b . . . , 50n of the user.

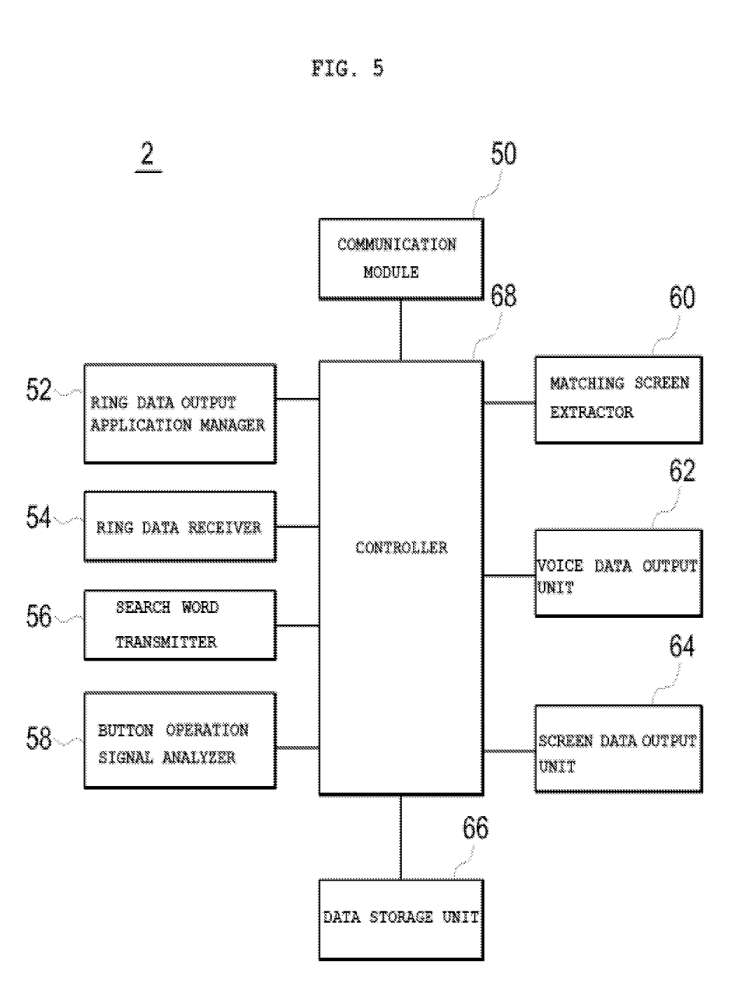

FIG. 5 is a schematic diagram illustrating a configuration of a user terminal included in the representative telephone information providing system having a search function according to the embodiment of the present invention.

Referring to FIG. 5, the user terminal 2 includes: a communication module 50 which is connected to a voice communication network or a data communication network in the user terminal 2 to perform communications; a ring data output application manager 52 which manages a driving of the ring data output application; a ring data receiver 54 which receives the ring data of the searched business; a search word transmitter 56 which transmits the search words input by the user to the ring data management server; a button operation signal analyzer 58 which analyzes button signals input by the user; and a matching screen extractor 60 which extracts screen data matched to the button signals input by the user.

Further, the user terminal 2 includes: a voice data output unit 62 which outputs voice data output by being call connected to a telephone number; a screen data output unit 64 which outputs the pre-matched screen data on a screen depending on the button selection; a data storage unit 66 which stores the ring data including the screen data packet and stores the key operation information matched so as to output each screen data and the identification codes for each screen data; and a controller 68 which performs a control to transmit the input search words to the ring data management server 40 by driving the ring data output application, and receive the ring data corresponding to the result so as to selectively output the plurality of screen data included in the ring data on the screen, corresponding to the key operation signal input by the user.

In this case, when selecting the ARS telephone number of the ring data, the controller 68 performs a control to extract the screen data by matching the button selection of the user at the time of the ARS voice communication, and output the extracted screen data on the screen.

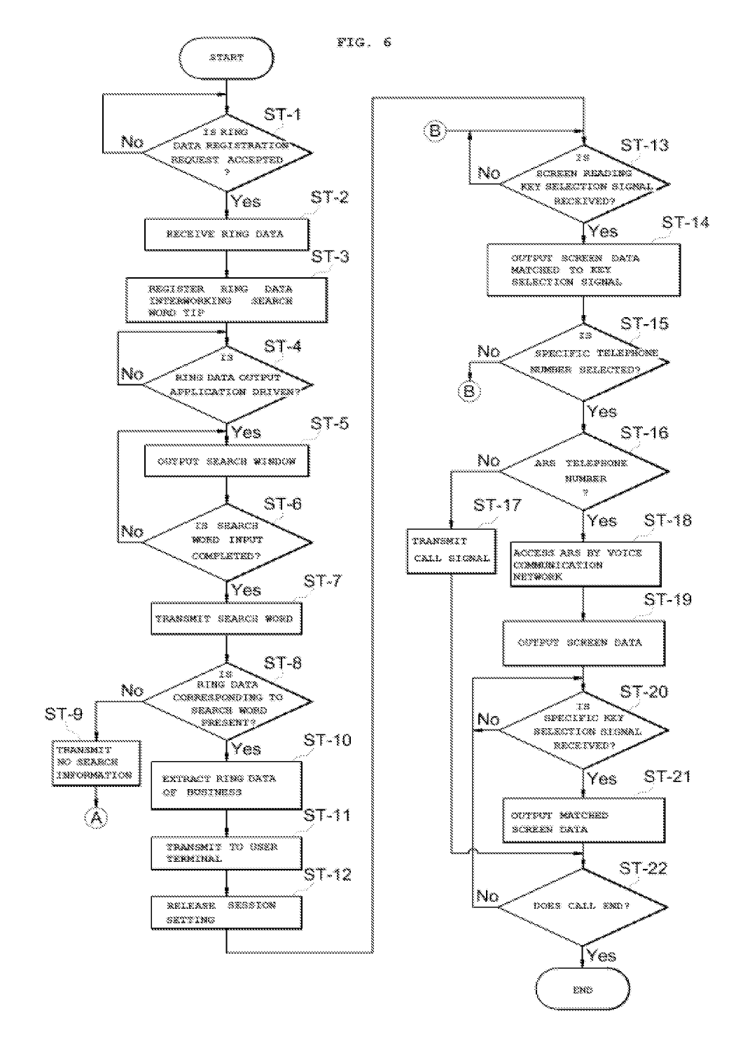

A function and an operation of the representative telephone information providing system having a search function according to the embodiment of the present invention having the above-described construction will be described in detail with reference to FIG. 6.

FIG. 6 is a flow chart illustrating a signal flow of the representative telephone information providing system having a search function according to the embodiment of the present invention.

First, the ring data management server 40 receives the ring data including the business information and the telephone number information from a plurality of businesses and receives a registration request signal.

Then, the ring data management server 40 matches the ring data with a searchable search word tip and stores the matched ring data.

In this state, the user drives the ring data output application which is equipped in the user terminal 2 and inputs the search words to the search word input window of the ring data output application.

Then, the ring data output application of the user terminal 2 transmits the search word to the ring data management server 40.

Next, the ring data management server 40 searches for the search word in a database and the ring data management server 40 extracts the ring data matched to the search word and transmits the extracted ring data to the user terminal 2 and releases session setting.

In this case, the ring data management server 40 searches for whether the search word is present in the database. In this case, when the search word is not present, the ring data management server 40 transmits no search information to the user terminal 2.

On the other hand, when the user terminal 2 receives the ring data including the plurality of screen data, the ring data output application determines whether the input of the key selection signal is present.

When the specific key selection signal is input, the user terminal 2 extracts the screen data matched to the key selection signal through the ring data output application and outputs the extracted screen data. Therefore, each screen data is allocated with identification codes as to whether each screen data is output depending on what key selection signals each screen data correspond to.

In this case, the user terminal 2 determines whether a telephone number selection signal included in the screen data is applied. In this case, when the telephone number selection signal is applied, it is determined whether the applied telephone number is the ARS number, and if it is determined that the telephone number is not the ARS number, a call connection to the telephone number is requested.

In this case, the telephone number may be any one of the business representative telephone number, the business ARS telephone number, the department telephone number, and the telephone numbers of persons in charge for each department.

If it is determined that the telephone number is the ARS number, the user terminal 2 executes the call connection to the ARS number and outputs the screen data having the same content as the ARS voice content.

Further, the matched screen data are extracted and output depending on whether the key selection signal is applied. When the call ending signal is applied, the driving of the ring data output application stops. On the other hand, when the key selection signal is continuously applied, an operation of outputting the matched screen data is repeated.

Meanwhile, the representative telephone information providing system having a search function and a method thereof according to the embodiment of the present invention are not limited to the above-described embodiments, and variations may be made therein without departing from the scope of the present invention as defined by the appended claims.

What is claimed is:

1. A system for providing representative telephone information, comprising:
a user terminal having a ring data search function to receive ring data which include business information or information on an ARS service or a telephone number of a person in charge for a specific department so as to release a session for a data communication network, and extract and output screen data depending on a key operation signal of a user with the session being released; and
a ring data management server configured to receive the ring data which include the business information or the information on the ARS service or the telephone number of a person in charge for a specific department from a seller and upload the received ring data to be searched, extract the ring data corresponding to search words transmitted from the user terminal, and transmit the extracted ring data to the user terminal.

2. The system of claim 1, wherein the user terminal is equipped with applications which extract predefined screen data depending on a specific key signal input by a user and output the extracted data on a screen.

3. The system of claim 1, wherein each of the screen data, which is output depending on the key selection information posted on the screen data which is exposed on the current screen, has a unique identification code allocated thereto.

4. The system of claim 1, wherein the ring data include a plurality of ARS screen data packets which are output on the screen depending on a key selection with the user terminal being connected to the ARS telephone numbers of each business.

5. The system of claim 1, wherein the ring data include product information or advertising information of the business.

6. The system of claim 1, wherein the ring data are hyperlinked to generate a call signal at the time of selecting a telephone number included therein.

7. The system of claim 1, wherein the ring data include at least one of the business information, and information on the ARS service or the telephone number of a person in charge for a specific department.

8. The system of claim 1, wherein the user terminal comprises:
a communication module connected to a voice communication network or a data communication network in the user terminal to perform communications;
a ring data output application manager configured to manage a driving of a ring data output application;
a ring data receiver configured to receive ring data of a searched business;
a search word transmitter configured to transmit the search words input by the user to the ring data management server;
a button operation signal analyzer configured to analyze button signals input by the user;
a matching screen extractor configured to extract the screen data matched to the button signals input by the user;
a voice data output unit configured to output voice data output by being call connected to a telephone number;
a screen data output unit configured to output the pre-matched screen data on a screen depending on the button selection;
a data storage unit configured to store the ring data including the screen data packet, and store key operation information matched so as to output each screen data and identification codes for each screen data; and
a controller configured to perform a control to transmit the input search words to the ring data management server by driving the ring data output application, and receive the ring data corresponding to the result so as to selectively output the plurality of screen data included in the ring data on the screen, corresponding to the key operation signal input by the user.

9. The system of claim 8, wherein when selecting the ARS telephone number of the ring data, the controller performs a control to extract the screen data by matching the button selection of the user at the time of ARS voice communication and output the extracted screen data on the screen.

10. A method for providing representative telephone information, comprising:
a first step of driving a ring data output application equipped in a user terminal;
a second step of determining whether search words are input to a search input window of the ring data output application;
a third step of transmitting, by the ring data output application of the user terminal, the search word to a ring data management server;
a fourth step of searching for, by the ring data management server, the search word in a database;
a fifth step of extracting, by the ring data management server, ring data matched to the search word and transmitting the extracted ring data to the user terminal;
a sixth step of releasing, by the ring data management server, session setting;
a seventh step of determining, by the ring data output application of the user terminal, whether a key selection signal is input;
a eighth step of extracting screen data matched to the key selection signal through the ring data output application and outputting the matched screen data, when the specific key selection signal is input;
a ninth step of determining, by the user terminal, whether a telephone number selection signal included in the screen data is applied; and
a tenth step of generating a call signal to the telephone number.

11. The method of claim 10, wherein the ring data are a packet including a plurality of screen data.

12. The method of claim 10, wherein each screen data included in the ring data is allocated with a unique identification code for each key signal so as to output the screen data depending on the key operation signal selected by a user.

13. The method of claim 10, further comprising:
Prior to the first step, a step of receiving, by the ring data management server, the ring data including business information and telephone number information from a plurality of businesses; and
a step of matching the ring data with a searchable search word tip.

14. The method of claim 10, wherein the telephone number is at least one of a business representative telephone number, a business ARS telephone number, a department telephone number, and telephone numbers of persons in charge for each department.

15. The method of claim 10, further comprising:
when the telephone number is an ARS telephone number in the tenth step, after the tenth step, an eleventh step of executing, by the user terminal, a call connection to the ARS number;
a twelfth step of outputting screen data having the same content as a ARS voice content;
a thirteenth step of determining whether a key selection signal is applied;
a fourteenth step of extracting and outputting the screen data matched to the key selection signal; and
a fifteenth step of determining whether a call ending signal is applied.
